(19) United States
(12) Patent Application Publication
(10) Pub. No.: US 2018/0116171 A1
(43) Pub. Date: May 3, 2018

(54) Folding Head Restraint

(71) Applicant: Brandon Beavers, Lebanon, KY (US)

(72) Inventor: Brandon Beavers, Lebanon, KY (US)

(21) Appl. No.: 15/801,416

(22) Filed: Nov. 2, 2017

Related U.S. Application Data
(60) Provisional application No. 62/416,746, filed on Nov. 3, 2016.

(51) Int. Cl. A01K 1/06

(52) U.S. Cl. CPC A01K 1/0613; A61D 2003/003

(57) ABSTRACT

A folding head restraint mounted to a cattle hoof trimming chute. The head restraint is mounted at the head gate of the chute and positioned so that the animal's head will be in the head restraint when the chute is in the layover position. The head restraint has a flat center brace and two folding side braces that rotate to the perpendicular when the chute is rotated to the layover position. The side braces are moved by a hydraulic piston operated by remote control. The movement of the side braces correspond to the movement of the chute from the upright to the horizontal position. As the chute rotates the side braces move to perpendicular. This shield's the animal's head, and also helps calm the animal.

### CROSS REFERENCE TO RELATED APPLICATIONS

This application claims priority to U.S. provisional application Ser. No. 62/416,746, filed on Nov. 3, 2016, the teaching of which is fully incorporated herein.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates to a head restraint for use with a hoof trimming chute for cattle. More particularly the invention relates to a folding head restraint that protects the animal's head and shields the animal's eyes and field of vision to help calm the animal during the hoof trimming process.

### Description of the Related Art

Hoof trimming chutes are known in the art. They are cage-like structures that hold and immobilize animals, primarily cattle, for the purpose of trimming their hooves. In some cases the animals are lain upon their sides to make the hooves accessible for trimming. One such hoof trimming chute is presented in U.S. Pat. No. 9,591,829 (the '829 patent) to Brandon Beavers, the current application. This application incorporates the teachings of that application by reference. While there are many unique features of the '829 patent, the general hoof trimming procedure is common to most hoof trimming chutes. A cow is herded into the chute, and it's head is moved through a head gate. The head gate closes, which prevents the animal from moving either forward or backward. In many chutes there is some form of side bar that is pressed against the animal to hold it into place within the chute. Once the animal is fully restrained the chute is rotated onto its side, which places the animal on its side. This is often refereed to as a lay-over chute. Once in this position the animal's legs are extending out from the chute and in position to be inspected and have the hooves trimmed. The hooves are typically trimmed with a power sander or similar instrument which grinds down the excess hoof material. Many chutes, such as the '829 chute, have flat head rests that provide stability for the animal's head when the layover chute is in the horizontal position and the animal is on its side. That head rest is a flat sheet of metal covered with rubberized matting material for cushioning. The head restraint of this application is designed to work with the hoof trimming chute of the '829 patent, but can be used with any other commercially available hoof trimming chute.

One of the problems encountered in trimming cattle hooves is that the animal often becomes upset and thrash about when in the lay-over or horizontal position in a hoof trimming chute. This is because this is an unnatural position for the animal. This makes it difficult to hold or secure the animal's legs for trimming the hooves. Cows typically become calm when their eyes are covered or shielded from a perceived danger. The present invention shields the animal's eyes to help calm the animal and improve the trimming process. Another problem encountered in trimming cow's hooves is that hoof particles fly through the air during the trimming process. These flying particles can enter the animal's eyes and nostrils and can irritate the animal. The present invention shields the animal's eyes and head from flying debris.

### SUMMARY OF THE INVENTION

The head restraint of the present invention consists of a tri-fold assembly with a center brace having covering padding, and two folding side braces that fold up at ninety degrees and effectively constrains and largely encircles the animal's head and limit the animal's field of vision. Cattle are typically docile animals, and when their heads are covered, or their field of view is limited, they typically react by becoming passive. The head restraint of the present invention provides sufficient restraint and limits the animal's field of vision to ensure the animal remains calm during the hoof trimming operation. The sides of the head restraint are flat when the animal enters and leaves the hoof trimming chute, and then rotate to perpendicular from the flat portion when the chute is in the fully horizontal position, thus preventing the animal from seeing its hooves being trimmed.

### BRIEF DESCRIPTION OF THE DRAWINGS

FIG. 1 is a front perspective view of the folding head restraint in the folded position and without protective matting, and attached to a representative hoof trimming chute.

FIG. 2 is a side perspective view of the chute in the upright position and the folding head restraint in the open position without matting.

FIG. 3 is a detailed perspective view of the folding head restraint in the folded position without protective matting.

FIG. 4 is a front perspective view of the folding head restraint in the folded position with protective matting.

FIG. 5 is a perspective view of the rear of the folding head restraint in the open position and showing the controlling mechanisms on the rear of the head restraint.

FIG. 6 is a front view of the folding head restraint in the folded position and showing the controlling mechanisms.

FIG. 7 is a front perspective view of the folding head restraint attached to a representative hoof trimming chute, with a cow's head in the folding head restraint.

### DETAILED DESCRIPTION OF THE INVENTION

Detailed embodiments of the present invention are disclosed herein. It is to be understood that the disclosed embodiments are merely exemplary of the invention, and that there may be a variety of other alternate embodiments. The figures are not necessarily to scale, and some features may be exaggerated or minimized to show details of particular components. Therefore, specified structural and functional details disclosed herein are not to be interpreted as limiting, but merely as a basis for teaching one skilled in the art to employ the varying embodiments of the present invention.

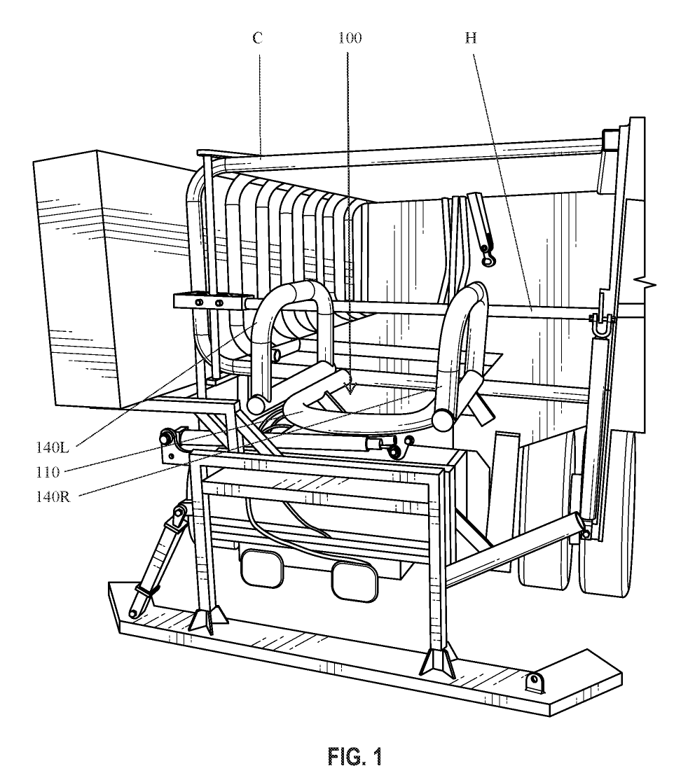

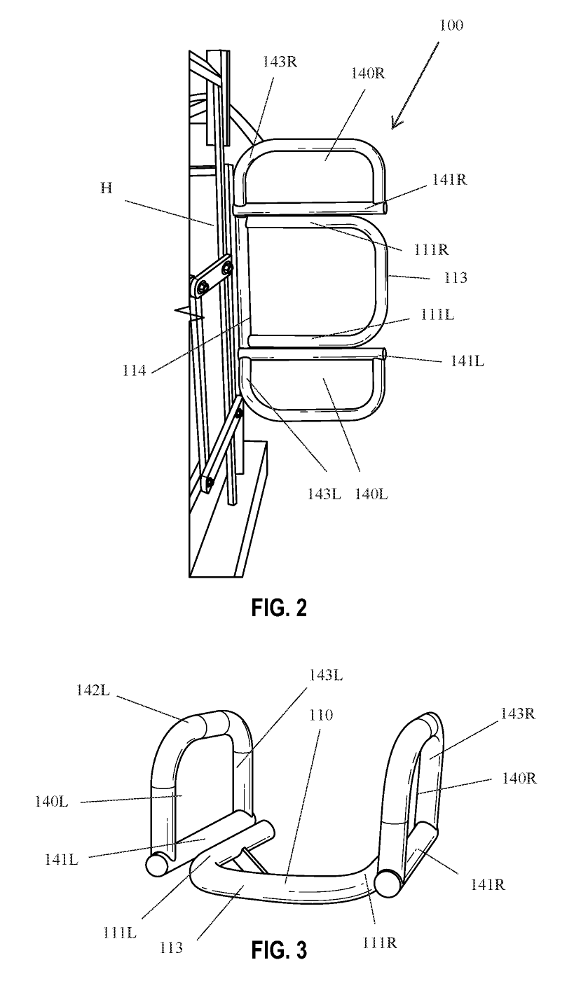

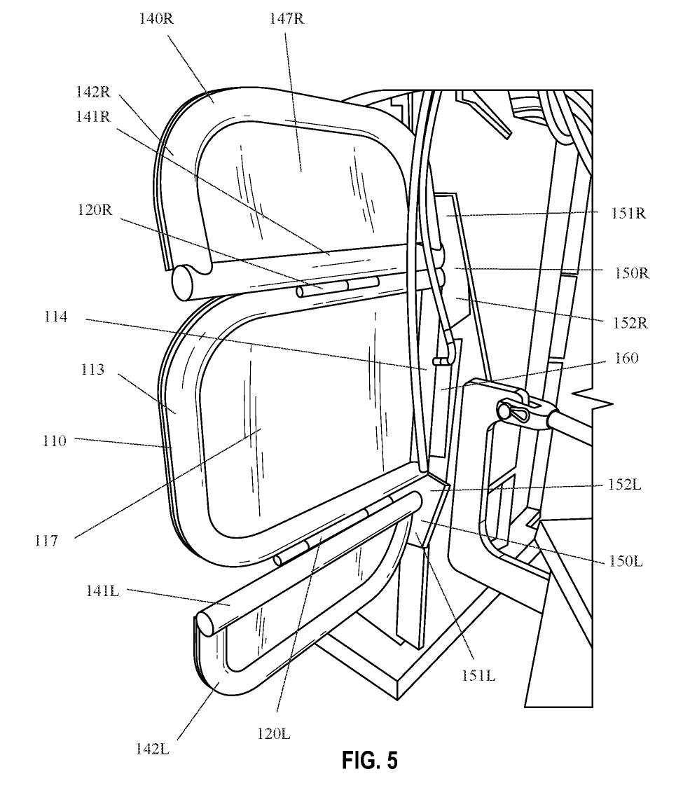

The head restraint 100 consists of a U-shaped center brace 110 that is attached to the head gate H area on the front end of a standard hoof trimming chute C, and two D-shaped side braces 140L and 140R that are attached to the center brace 110 by hinges 120L and 120R, and fold up to protect the animal's head during hoof trimming. FIG. 1 shows the folding head restraint 100 attached to a representative hoof trimming chute C. In one alternative embodiment the center brace can be attached to an attachment plate 200 with holes or other mounting mechanisms to allow the head rest to be mounted on any standard hoof trimming chute. FIG. 2 and FIG. 5 shows the head restraint 100 in the open position when the chute C is in the upright position. The head restraint 100 will generally always be in the open position when the chute C is in the upright position. This allows the cow's head to easily go through the head gate H when entering the chute C, and allows the animal to be unconstrained when exiting the chute C after the trimming has been completed.

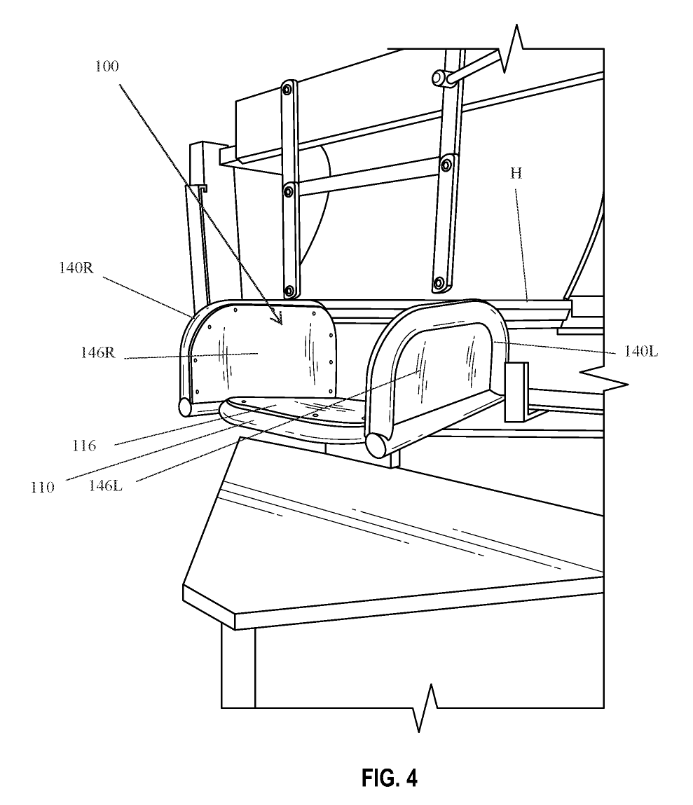

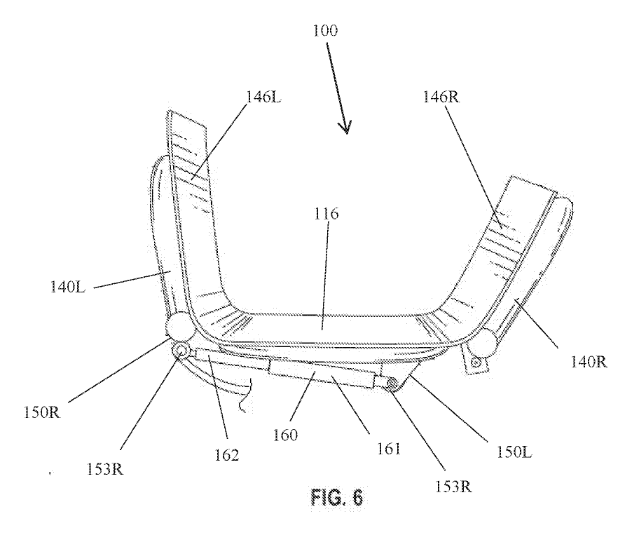

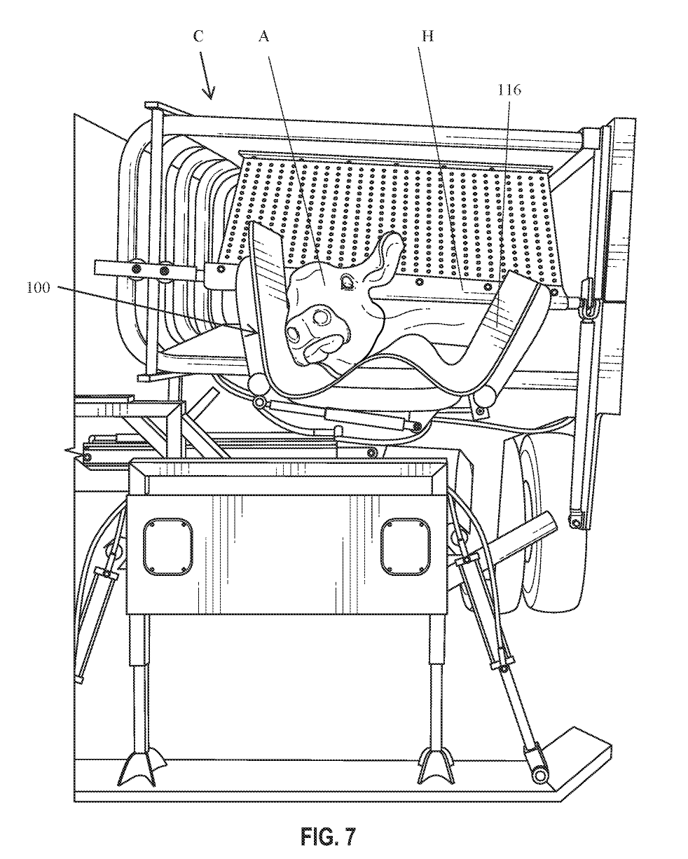

FIG. 3, FIG. 4, FIG. 6, and FIG. 7 show the folding head restraint 100 in the folded position. The head restraint 100 will typically be in the folded position when the chute C is in the horizontal or layover position, when the animal is in the chute C. The U-shaped center brace 110 is a curved piece of tubular steel that is bent to form a U-shaped member. In the preferred embodiment the left side 111L and the right side 111R of the U are approximately 24 inches long on the sides, and 24 inches wide at the top 113. The center brace 110 is butt-welded at the bottom 114 of the center brace to the attachment plate 200 and the attachment plate is attached to the head gate H area of the hoof trimming chute C by welding or bolting or other means. In one embodiment the center brace 110 is attached directly to the chute C. The head rest 100 is attached at approximately the position of where an average sized cow, which is approximately five feet off the ground when the chute C is in the upright position.

As best seen in the rear open view of FIG. 5, there are two hinges 120L and 120R mounted on the back 117 of the center brace 110, one on each side, so there is a right hinge 120R and a left hinge 120L. There are two D-shaped side braces, a left D-shaped side brace 140L and a right side brace 140R, with the right side brace 140R mounted on the right hinge 120R and the left side brace 140L mounted on the left hinge 120L. This means that part of the hinge 120 is on the side brace 140 and part is on the center brace 110 with an internal pin between them, as is known for hinges. The side braces 140R and 140L are roughly D-shaped. The D-shaped portion of the side braces 140 are made from a single piece of metal tubing bent into a roughly D-shape. There is a bottom bar 141 on each side brace 140 so a left bottom bar 141L and a right bottom bar 141R. The bent portion of the side brace is the curved D-bar 142, with a right D-bar 142R and a left D-bar 142L. The bent D-bar 142 is butt welded onto the bottom bar 141, and a hinge is mounted on the D-bar, which is attached to the hinge 120 of the center brace 110. The hinge 121 on the center brace is attached, typically be welding, approximately three-quarters of the way around the side of the center brace.

It is to be understood that the shape of the center brace 110 and the two side braces 140 in the preferred embodiments are for illustrative purposes only, and that the center brace 110 and the two side braces 140L and 140R can be square or rectangular. The center brace is U-shaped in the preferred embodiment because it is made from a single piece of bent steel tubing. It is possible, and within the conception of the invention for the center brace to be made of a single piece of flat metal. In this configuration there should be a couple of pieces of padding material to protect the animals head while the chute is in the layover position. The side braces can also be made of a single piece of flat material.

In the preferred embodiment the U-shaped center brace and the two D-shaped side braces are made from 2″ nominal diameter schedule 40 steel pipe or tubing. This material is selected for its strength and durability. However the size and strength of the braces can vary slightly. Because the head restraint 100 does not bear significant weight the tubing can be slightly smaller than the tubing for the rest of a standard restraining chute. It can also be slightly larger.

There is a center brace pad 116 attached to the front 115 of the center brace 110. In the preferred embodiment the center brace pad 116 is made form standard ½′ inch thick rubberized matting, which is cut in the same U-shaped pattern and dimensions as the center brace 110. The center brace pad 116 is attached to the center brace 110 by standard means, which can include gluing or other adhesives, metal screws, rivets, or any appropriate attachment means. The use of matting material means that there is some give, and hence some cushioning for the animal's head when the chute and head restraint 110 are in the horizontal position. There are two side pads 146R and 146L attached to the two side braces 140 R and 140L. The side pads 146 are cut to the size and shape of the side braces 140R and 140L and attached in the same manner as the center brace pad 116. The separate center brace pad 116 and side brace pads 146L and 146R can best be seen in FIG. 4 and FIG. 5. In the preferred embodiment the matting placed on the U-shaped center brace and two D-shaped sides brace are made from standard ½″ (one-half inch) conveyor belt matting. In an alternate embodiment, shown in FIG. 6 and FIG. 7, there is a single piece of matting that covers both the center brace 110 and both side braces 140R and 140L. The center brace pad 116 provides cushioning for the animal's head when the chute C is in the horizontal position, and the side brace pad 146L and 146R provide padding should the animal thrash its head, provides protection from flying debris, and also limits the animal's field of vision.

As seen in FIG. 5 and FIG. 6, there is a rotation bar 150 attached to the back 147 of each of the D-shaped side braces 140, so a left rotation bar 150L and a right rotation bar 150R. The rotation bars 150 are attached on the cage side 143 of the D-shaped side brace 140. This places the rotation bars 150 R and 150 L near or adjacent to the head gate area of the layover chute. The rotation bars have an attached end 151 and an extending end 152, with a hole 153 on the extending end 152. As seen in FIG. 5 and FIG. 6, the rotation bars 150 are roughly rectangular. There is a piston 160 attached between the two rotation bars 150. The piston 160 has a cylinder 161 and an extending arm 162, and each has a round attachment grommet at the end. This allows the piston 160 to be attached by means of a pin in each of the holes 153L and 153R. When the extending arm 162 is retracted into the cylinder 161 the rotation bars 150L and 150R are pulled together. Because of the geometry of the rotation bars 150L and 150R on the D-shaped side braces 140L and 140R, when the piston 160 is retracted the rotation bars 150 are pulled together and the D-shaped side braces 140L and 140R are folded down, leaving the side braces 140L and 140R flat with the center brace 110. When the piston 160 is activated, the extending arm 162 extends, forcing the rotation bars 150L and 150R apart, which forces the side braces 140 to rotate on the hinges 120L and 120R, rotating the side braces 140 upward. When the piston 160 is fully extended the side braces 140L and 140R are perpendicular to the center brace 110. It is also possible, and within the conception of the invention, to mechanically link the rotation bars 150 to the chute so that when the chute rotates from the upright to the horizontal positions the rotation bars 150 are pressed apart and the side braces 140 close.

Many hoof trimming chutes, such as but not exclusively including the '820 patent, have remote controllers to operate the hydraulic pistons that move the components of the chute. This is described in detail in the '829 patent. In this particular system a hand held remote control links by radio waves to a controller on the servo-motor that activates the pump that controls the piston 160. If the chute C is controlled by a remote control device that controls all of the other hydraulic functions of the chute, it is a simple matter to integrate the control for the head restraint piston 160 with the existing remote control system, and a button added to the hand held remote controller that controls each components. Other chutes use physical levers to control the hydraulics, and a lever can be added to the chute to also control the head restraint. It is also possible to include a separate hand held remote control device to control the piston 160 and the position of the side braces 140R and 140L of the head restraint 100.

In use, an animal A, typically a cow, is herded into the layover chute C for the purpose of having it's hooves trimmed. This is described in some detail in the '829 patent. The animal's head extends from the front of the hoof trimming chute C, and a head gate H is closed to prevent the animal from moving forward and out of the chute, or pulling its head back in. The physiology of a cow prevents the animal from pulling its head backward. The folding head restraint 100 of the present invention is placed on the side of the chute at the head gate H, and at the level of the typical cow, which is typically about five feet above the ground. Once the cow A is in the chute C and the head gate H is closed the chute C is tilted onto its side to allow the animal's hooves to be exposed and trimmed.

As the chute C is tiled into the horizontal position the piston 160 of the head restraint 100 is activated and extends, forcing the rotation bars 150L and 150R to rotate the side braces 140L and 140R upwardly. Once the chute C is in the fully horizontal position the two side braces 140L and 140R are fully up, and roughly perpendicular to the surface of the center brace 110. This means that the cow's head is laying on the center brace padding 116, and its head is shielded on two sides. This is shown in FIG. 6, which shows a representative chute C in the horizontal position, with a cow A laying down and with the head gate H closed to prevent the cow from puling its head out of the gate H, and with the cows head cradled in the folding head restraint 100. The folding head restraint 100 depicted in FIG. 6 is an alternate embodiment using a single piece of matting to cover both side braces 140R and 140L as well as the center brace 110.

Once the hoof trimming or other veterinarian procedure is complete, the chute C is rotated back to place the animal A in the upright position. As the chute rotates the side braces 140L and 140R of the head restraint 100 are also rotated back to the flat position. Once the chute is fully upright the head restraint 100 will be fully flat and in the same plane as the inside wall of the chute C, as seen in FIG. 2 and FIG. 5. This means that when the head gate H is opened the head restraint 100 is flat and out of the way of the animal as it departs the chute.

The present invention is well adapted to carry out the objectives and attain both the ends and the advantages mentioned, as well as other benefits inherent therein. While the present invention has been depicted, described, and is defined by reference to particular embodiments of the invention, such reference does not imply a limitation to the invention, and no such limitation is to be inferred. The depicted and described embodiments of the invention are exemplary only, and are not exhaustive of the scope of the invention. Consequently, the present invention is intended to be limited only be the spirit and scope of the claims, giving full cognizance to equivalents in all respects.

I claim:

1. A folding head restraint for a hoof trimming chute, said head restrain comprising:
a center brace attached to the hoof trimming chute:
two side braces rotatably attached to said center brace;
wherein said side braces rotate to place said side braces perpendicular to said center brace, thereby partially enclosing the head of an animal in said hoof trimming chute.

2. The folding head restraint of claim 1, wherein said center brace consists of a U-shaped member made from bent tubing and covered with rubberized matting to create a cushioning surface on said center brace.

3. The folding head restraint of claim 2, wherein said side brackets are rotatably attached to said center brace by means of hinges.

4. The folding head restraint of claim 2, wherein;
said center brace has a left side, a right side, and a bottom end attached to a front end of the hoof trimming chute;
one of said side braces attached to the left side of said center brace by a hinge, and the other of said side braces attached to the right side of center brace by a hinge.

5. The folding head restraint of claim 3, further consisting of;
a piston attached between said side braces where said piston controls the movement of said side braces.

6. The folding head restraint of claim 5 further comprise:
Two rotation bars, one attached to the back of the first side brace and the other attached to the back of the second side brace, wherein said piston is attached between the two rotation bars so that when the piston is extended the rotation bars force the side braces to rotate on said hinges and move said side braces to said perpendicular position.

7. The folding head restraint of claim 5, wherein said piston is controlled remotely by a hand held controller.

8. The folding head restraint of claim 6 wherein said chute is rotated from an upright position when an animal enters to a horizontal position for trimming the animal's hooves, and wherein the movement of said side braces correspond to the movement of said chute such that when said chute is in the horizontal position the side braces are in the perpendicular position so that said head restraint holds said animal's head, and said side braces shield the field of vision of the animal.

9. A folding head restraint for a hoof trimming chute, said head restrain comprising:
a U-shaped center brace made of a single piece of metal tubing bent into a U-shaped member, said U-shaped center brace having a bottom end, a left side and a right side, wherein said U-shaped center brace is attached to said hoof trimming chute as said bottom end; said U-shaped brace further having a front side and a back side;
a center brace matting sized to cover and attach to said center brace to provide cushioning for the animal's head when in the head restraint;
two D-shaped side braces, each made from a single piece of metal tubing bent into a D-shape, said D-shaped side brackets having a front side, a back side, and a bottom end;
wherein the first of said side braces is attached to the left side of said U-shaped center brace by means of a hinge, and the second of said side braces is attached to the right side of said U-shaped center brace by means of a hinge:
side brace matting attached to the front of said two D-shaped side brackets to provide shielding for the animal's head when in the folding head restraint;
two rotation bars, one attached to the back side of the first side brace and the other attached to the back side of the second side brace;
a piston mounted between said first rotation bar and said second rotation bar wherein when the piston is extended the rotation bars are pushed thus rotating the side braces into the perpendicular position, and when the piston is withdrawn the side braces are rotated into the parallel position;
wherein, when an animal is in the hoof trimming chute and the hoof trimming chute is rotated into a horizontal position for trimming the hooves said side braces are simultaneously rotated into the perpendicular position so that when the hoof trimming chute is in the fully horizontal position the side braces are in the fully perpendicular position, thereby shielding the animal's head during the hoof trimming procedure.
